(19) United States
(12) Patent Application Publication
(10) Pub. No.: US 2025/0199629 A1
(43) Pub. Date: Jun. 19, 2025

(54) PEN-TYPE ELECTRONIC APPARATUS

(71) Applicant: Murata Manufacturing Co., Ltd., Nagaokakyo-shi (JP)

(72) Inventors: Takashi KIHARA, Nagaokakyo-shi (JP); Keisuke NISHIMOTO, Nagaokakyo-shi (JP)

(21) Appl. No.: 19/069,915

(22) Filed: Mar. 4, 2025

Related U.S. Application Data
(63) Continuation of application No. PCT/JP2023/033001, filed on Sep. 11, 2023.

(30) Foreign Application Priority Data
Sep. 16, 2022 (JP) 2022-148509

(51) Int. Cl. G06F 3/0354; G01L 1/16

(52) U.S. Cl. CPC G06F 3/03545; G01L 1/16

(57) ABSTRACT

A pen-type electronic apparatus is provided that includes a cylindrical housing having a grip portion configured to be gripped by a user; a pen shaft housed inside the housing; a sheet-like pressure sensor wound around a position that overlaps the grip portion on an outer surface of the pen shaft or an inner surface of the housing; and a cushion material either between the pen shaft and the pressure sensor or between the pressure sensor and the housing. The pressure sensor has a low-sensitivity region in a central portion of the grip portion along a long axis direction of the pen shaft. The low-sensitivity region has a lower sensitivity for detecting pressure from the user than other regions of the pressure sensor.

### CROSS REFERENCE TO RELATED APPLICATIONS

This application is a continuation of International Application No. PCT/JP2023/033001, filed Sep. 11, 2023, which claims priority to Japanese Patent Application No. 2022-148509, filed Sep. 16, 2022, the contents of each of which are hereby incorporated by reference in their entirety.

### TECHNICAL FIELD

The present disclosure relates to a pen-type electronic apparatus including a grip portion configured to be gripped by a user.

### BACKGROUND

WO 2016/038951 A (hereinafter “Patent Document 1”) discloses a held-state detection apparatus (e.g., a pen-type electronic apparatus) including a housing having a shape that can be held by an operator, a piezoelectric sensor attached to the housing, and a detection unit that detects a held state of the housing using a variation amount of an output voltage of the piezoelectric sensor.

In the case of gripping the pen-type electronic apparatus as described in Patent Document 1, there can be a problem in that sensitivity is likely to change depending on a location where the pen-type electronic apparatus is gripped, and variation is likely to occur.

### SUMMARY OF THE INVENTION

Thus, it is an object of the present disclosure to provide a pen-type electronic apparatus that is configured to prevent variation in sensitivity depending on a place where the pen-type electronic apparatus is gripped.

Thus, in an exemplary aspect, a pen-type electronic apparatus is provided that includes a cylindrical housing having a grip portion configured to be gripped by a user; a pen shaft housed inside the housing; a sheet-like pressure sensor wound around a position overlapping with the grip portion on an outer surface of the pen shaft or an inner surface of the housing; and a cushion material either disposed between the pen shaft and the pressure sensor or between the pressure sensor and the housing. Moreover, the pressure sensor has a low-sensitivity region in a central portion of the grip portion along a long axis direction of the pen shaft. The low-sensitivity region has a lower sensitivity for detecting pressure from the user than other regions of the pressure sensor.

It is understood that, in general, sensitivity of the central portion of the grip portion along the long axis direction of the pen shaft is high and sensitivity of the other portions is low. Therefore, in the pen-type electronic apparatus of the present disclosure, the low-sensitivity region is provided in the central portion of the grip portion along the long axis direction of the pen shaft, so that variations in sensitivity are prevented depending on a location where the pen-type electronic apparatus is gripped.

According to the exemplary aspects of the present disclosure, variations in sensitivity depending on a place where the pen-type electronic apparatus is gripped are prevented.

### BRIEF DESCRIPTION OF DRAWINGS

FIG. 1 is an exploded perspective view of a pen-type electronic apparatus 1 according to an exemplary aspect.

FIG. 2 is a partially transparent side view of the pen-type electronic apparatus 1 according to an exemplary aspect.

FIG. 3 is a sectional view of the pen-type electronic apparatus 1 according to an exemplary aspect.

FIG. 4 is a partially sectional view taken along line A-A illustrated in FIG. 3 according to an exemplary aspect.

FIG. 5 is a sectional view illustrating a structure of a pressure sensor 20 according to an exemplary aspect.

FIG. 6 is a diagram illustrating, as a reference example, a difference in output voltage of the pressure sensor depending on a place where the pen-type electronic apparatus in a conventional configuration.

FIG. 7 is a view illustrating a section of a part of a grip portion 101 of the pen-type electronic apparatus 1 according to an exemplary aspect.

FIG. 8 is a diagram illustrating a difference in output voltage of the pressure sensor depending on a place where the pen-type electronic apparatus 1 is gripped in the pen-type electronic apparatus 1 according to an exemplary aspect.

FIG. 9 is a view illustrating a section of a part of a grip portion 101 in a pen-type electronic apparatus 1 according to a second modification of an exemplary aspect.

FIG. 10 is a view illustrating a section of a part of a grip portion 101 in a pen-type electronic apparatus 1 according to a fourth modification of an exemplary aspect.

FIG. 11 is a view illustrating a section of a part of a pressure sensor 20 in a pen-type electronic apparatus 1 according to a sixth modification of an exemplary aspect.

FIG. 12 is a view illustrating a section of a part of a grip portion 101 in a pen-type electronic apparatus 1 according to a seventh modification of an exemplary aspect.

FIG. 13 is a view illustrating a section of a part of the grip portion 101 of the pen-type electronic apparatus 1 according to an exemplary aspect.

FIG. 14 is a view illustrating a section of a part of a pressure sensor 20 in a pen-type electronic apparatus 1 according to an eighth modification of an exemplary aspect.

FIG. 15 is a view illustrating a section of a part of a pressure sensor 20 in a pen-type electronic apparatus 1 according to a ninth modification of an exemplary aspect.

### DETAILED DESCRIPTION

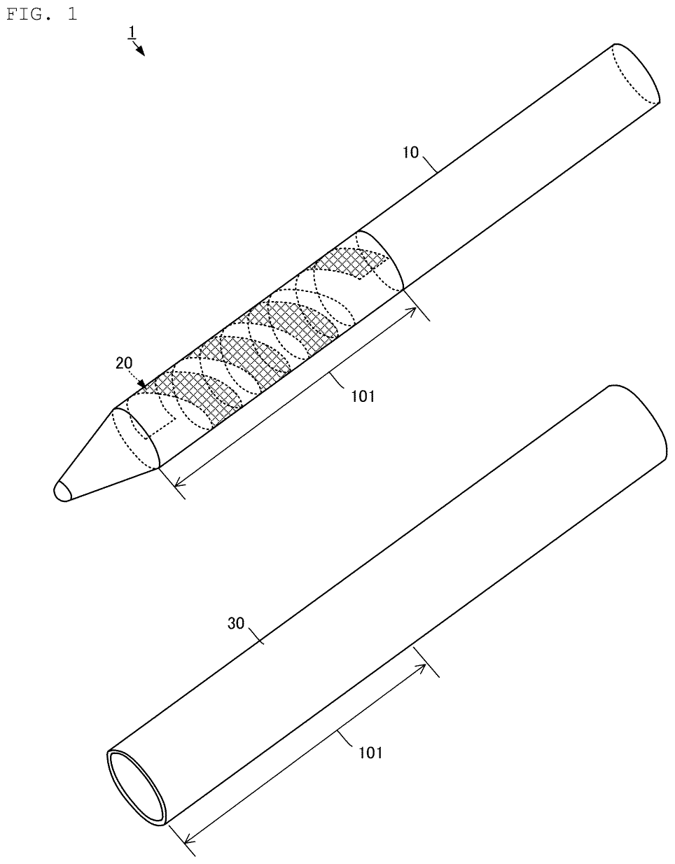

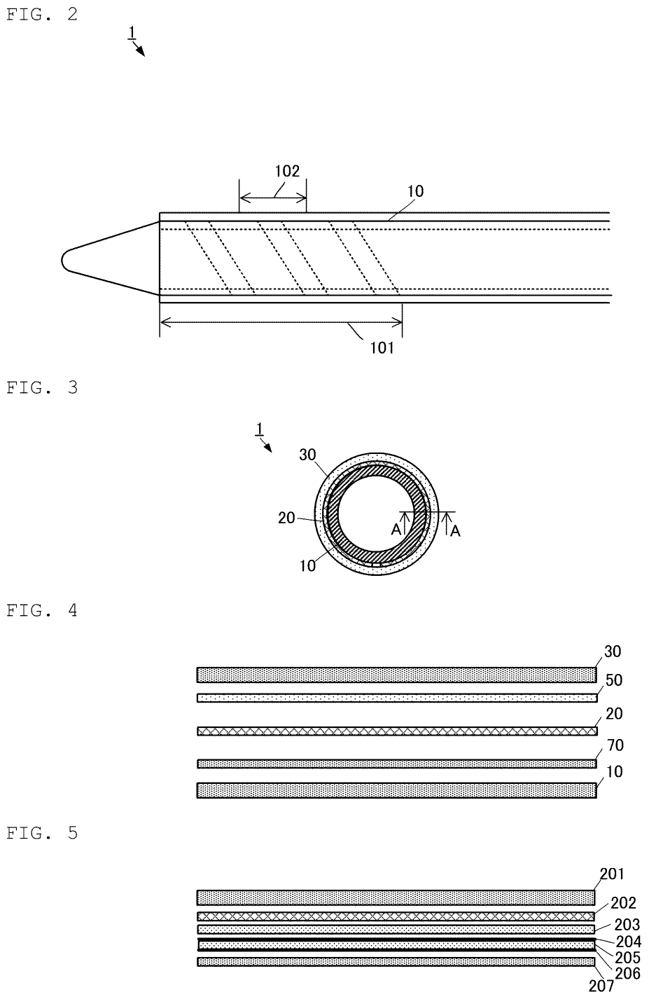

FIG. 1 is an exploded perspective view of a pen-type electronic apparatus 1. FIG. 2 is a partially transparent side view of the pen-type electronic apparatus 1. FIG. 3 is a sectional view of the pen-type electronic apparatus 1, and FIG. 4 is a partially exploded sectional view taken along line A-A illustrated in FIG. 3.

As shown, the pen-type electronic apparatus 1 includes a pen shaft 10, a pressure sensor 20, and a housing 30. The pen shaft 10 and the housing 30 each have a cylindrical shape. The housing 30 has a hollow shape so that the pen shaft 10 can be inserted into the housing 30. In addition, the pen shaft 10 can be hollow to house circuit components or the like, or can also have a buried shape. The pen shaft 10 and the housing 30 each include resin or metal having a Young's modulus of 1 GPa or more.

At one end of the pen shaft 10 in a longitudinal direction (a direction orthogonal to a circumferential direction), a tapered pen point is provided. An outer diameter of the pen shaft 10 is smaller than an inner diameter of the housing 30. The pen shaft 10 is housed inside the housing 30.

In operation, a user can grip a grip portion 101 close to the pen point in the housing 30. The user grips the grip portion 101 and brings the pen point into contact with another electronic apparatus (for example, a tablet computer or the like). When the user moves the pen point, the other electronic apparatus senses this movement to accept the user's operation input.

The pressure sensor 20 is a flexible sheet-like member and has an elongated shape. The pressure sensor 20 is spirally wound along an outer surface of the pen shaft 10 in a portion corresponding to the grip portion 101. However, it is not essential in the present invention that the pressure sensor 20 is spirally wound. For example, the pressure sensor 20 may be wound around an entire portion of the outer surface of the pen shaft 10 corresponding to the grip portion 101.

In addition, in general, the pressure sensor is often disposed in an entire required pressure detection region. However, when the pressure sensor is disposed in the entire region, an area of the pressure sensor increases, which is often a disadvantage in terms of cost. On the other hand, since the sheet-like pressure sensor 20 as illustrated in the present embodiment has an elongated shape and is spirally wound around the pen shaft 10, the area of the pressure sensor 20 can be reduced with respect to a desired area of the pressure detection region. Therefore, the pressure sensor 20 is preferably disposed in such a spiral shape.

As illustrated in FIGS. 3 and 4, the pressure sensor 20 is connected to the outer surface of the pen shaft 10 via a bonding member 70. That is, the bonding member 70 is disposed between the pen shaft 10 and the pressure sensor 20. In the present embodiment, the bonding member 70 is a double-sided tape. The bonding member 70 includes an acrylic adhesive or an adhesive having a Young's modulus of 100 kPa or more. It is noted that the bonding member 70 can have a same area as the area of the pressure sensor 20, or can have an area covering the entire portion of the outer surface of the pen shaft 10 corresponding to the grip portion 101 in an alternative aspect.

As illustrated in FIGS. 3 and 4, a cushion material 50 is disposed between the pressure sensor 20 and the housing 30. The cushion material 50 has a shrinkage property and includes a resin having a Young's modulus of 100 kPa or more and 1 GPa or less. The cushion material 50 can also have a same area as the area of the pressure sensor 20, or can have an area covering the entire portion of the outer surface of the pen shaft 10 corresponding to the grip portion 101. Further, the cushion material 50 can have an area covering the entire outer surface of the pen shaft 10 in another exemplary aspect.

As described above, the outer diameter of the pen shaft 10 is smaller than the inner diameter of the housing 30. Accordingly, the pen shaft 10 can be housed inside the housing 30. However, the pen shaft 10 may be larger or smaller than a target outer diameter due to a manufacturing error. The housing 30 may also be larger or smaller than a target inner diameter due to a manufacturing error.

If the outer diameter of the pen shaft 10 is larger than the target and the inner diameter of the housing 30 is smaller than the target, there is a case where the pen shaft 10 cannot be housed inside the housing 30. Therefore, the outer diameter of the pen shaft 10 is designed to be smaller than the target outer diameter by a predetermined value, and the outer diameter of the housing 30 is designed to be larger than the target inner diameter by a predetermined value. Thus, when a manufacturing error occurs, the pen shaft 10 can be housed inside the housing 30.

On the other hand, a space having a predetermined height is formed between the pen shaft 10 and the housing 30. However, in the present embodiment, the cushion material 50 is included between the pressure sensor 20 and the housing 30. The cushion material 50 has a shrinkage property. In a case where a thickness of the cushion material 50 is larger than the predetermined height, when the pen shaft 10 is housed inside the housing 30, the cushion material 50 shrinks, so that a space can be eliminated. As a result, when the user grips the housing 30, deformation due to the grip of the housing 30 is transmitted to the pressure sensor 20 via the cushion material 50.

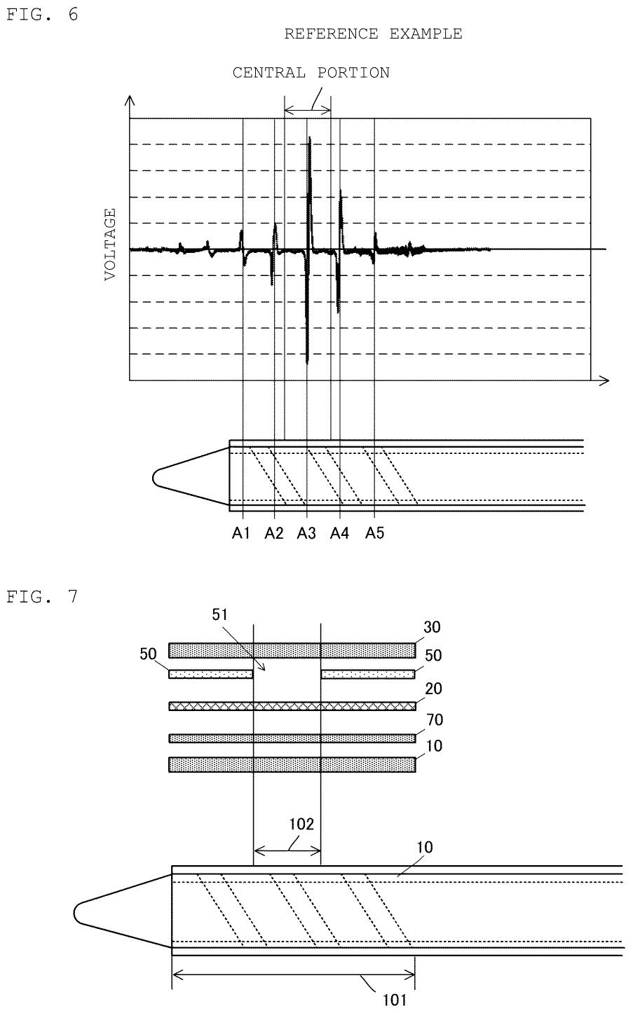

Next, FIG. 5 is a sectional view illustrating a structure of the pressure sensor 20. The pressure sensor 20 has a first electrode 201, a piezoelectric film 202, an adhesive member 203, a second electrode 204, an FPC 205, a third electrode 206, and a cover 207.

The first electrode 201 is disposed on a first principal surface of the piezoelectric film 202. The first electrode 201 is a tape member having adhesiveness and conductivity. The first electrode 201 is grounded and functions as a shield electrode.

According to an exemplary aspect, the piezoelectric film 202 is a piezoelectric material that generates polarization on the first principal surface (an upper surface) and a second principal surface (a lower surface) facing each other by expansion and shrinkage. For example, the piezoelectric film includes uniaxially stretched polylactic acid (PLA), PVDF, or the like. As the polylactic acid, any one of L-type polylactic acid (PLLA) and D-type polylactic acid (PDLA) is mentioned. The polylactic acid produces piezoelectricity during processing of orienting molecules by way of stretching or the like, and does not need to be subjected to poling processing unlike other polymers such as PVDF or a piezoelectric ceramics. The polylactic acid does not have pyroelectricity. Therefore, the polylactic acid does not cause polarization due to a body temperature of the user, and thus is preferable for the pen-type electronic apparatus as in the present embodiment.

The FPC 205 is a flexible insulating substrate of polyimide, PET, a liquid crystal polymer, or the like. The second electrode 204 is formed on an upper surface side (a piezoelectric film 202 side) of the FPC 205. The third electrode 206 is formed on a lower surface side of the FPC 205.

The second electrode 204 is stuck to the piezoelectric film 202 via the adhesive member 203. The second electrode 204 functions as a signal electrode for detecting a voltage generated on the second principal surface of the piezoelectric film 202. The third electrode 206 is grounded and can be configured to function as a shield electrode. However, it is noted that the electrodes do not need to be formed on both the first principal surface and the second principal surface of the FPC 205. The electrode may be formed on either the first principal surface or the second principal surface of the FPC 205. In this case, a shield electrode can be omitted.

The cover 207 has adhesiveness and is stuck to the third electrode 206 to protect the third electrode 206. However, it is noted that the cover 207 is not an essential component.

The first electrode 201 is stuck to the pen shaft 10 via the bonding member 70. However, the cover 207 may be stuck to the pen shaft 10 via the bonding member 70. Alternatively, the pressure sensor 20 may be stuck to an inner surface of the housing 30. In this case, the bonding member 70 is disposed between the pressure sensor 20 and the housing 30. In addition, in this case, the cushion material 50 is disposed between the pressure sensor 20 and the pen shaft 10.

A detection circuit (not illustrated) measures a potential difference (e.g., a voltage) between the first electrode 201 and the second electrode 204. When detecting a voltage exceeding a predetermined threshold, the detection circuit determines that the grip portion 101 is gripped by the user.

When the user grips the grip portion 101, the housing 30 is first deformed. When the housing 30 is deformed, the cushion material 50 is also deformed. When the cushion material 50 is deformed, the pressure sensor 20 is also deformed in accordance with the deformation of the cushion material 50. In the pressure sensor 20, when the pen shaft 10 is not deformed, a lower surface side of an inside of the pressure sensor 20 is not deformed and an upper surface side is deformed.

At this time, the adhesive tape 70 has an effect of fixing one surface of the pressure sensor 20 to the pen shaft 10. By fixing the one surface of the pressure sensor 20 to the pen shaft 10, both displacement of the pressure sensor 20 and/or occurrence of an unexpected sensor output due to unintended deformation can be suppressed. When a pressure is applied to the sensor 20, deformation in an extending direction or a shrinking direction occurs with respect to the second electrode 204, the FPC 205, and the third electrode 206. As a result, distortion in the same direction is generated in the adhesive member 203, and the distortion is transmitted to the piezoelectric film 202. As a result, since strain in the extending direction or the shrinking direction is generated in the piezoelectric film 202, an electric field is generated in a thickness direction of the piezoelectric film 202 in accordance with characteristics of a piezoelectric body, and an output of the sensor is obtained.

Further, when the pen shaft 10 is deformed together with the pressure sensor 20, each of the layer members of the pressure sensor 20 is deformed. As a result, deformation in a bending direction is generated in the second electrode 204, the FPC 205, and the third electrode 206. As a result, the second electrode 204 and the third electrode 206 are deformed in the extending direction or the shrinking direction. As a result, distortion in the same direction is generated in the adhesive member 203, and the distortion is transmitted to the piezoelectric film 202. As a result, since strain in the extending direction or the shrinking direction is generated in the piezoelectric film 202, an electric field is generated in a thickness direction of the piezoelectric film 202 in accordance with characteristics of a piezoelectric body, and an output of the sensor is obtained.

Therefore, the output of the sensor can be changed by changing configurations of the housing and an inside of the housing.

When the user grips a grip portion of the pen-type electronic apparatus, a case where the user grips a center of the pressure detection region and a case where the user grips an end portion of the detection region are assumed. In the case where a central portion of the pressure detection region is gripped, a sensor region to which the pressure is applied is a wide region, whereas in the case where the end portion is gripped, a sensor region to which the pressure is applied is a narrower region than in the case where the pressure is applied to the central portion. Therefore, in the case where the end portion is gripped, the sensor output becomes smaller than that in the case where the center is gripped. As a result, there is a problem that the sensor output tends to vary inside the pressure detection region.

FIG. 6 is a diagram illustrating, as a reference example, a difference in output voltage of the pressure sensor depending on a place where the pen-type electronic apparatus is gripped in a conventional configuration. A horizontal axis of a graph in the drawing corresponds to a grip position of the pen-type electronic apparatus, and a vertical axis is the voltage.

As illustrated in FIG. 6, when the user grips the grip portion of the pen-type electronic apparatus, a grip position A3 in a central portion of the pressure sensor disposed portion indicates a very high voltage. A grip position A2 and a grip position A4 deviated from the central portion indicate low voltages, and a grip position A1 closest to the pen point and a grip position A5 farthest from the pen point indicate very low voltages.

When detecting a voltage exceeding the predetermined threshold, the detection circuit determines that the pen-type electronic apparatus is gripped by the user. Here, when the threshold is set corresponding to the voltage when the grip position A3 in the central portion is gripped, the detection circuit cannot determine that the pen-type electronic apparatus is gripped when another grip position is gripped. On the other hand, when the threshold is set corresponding to the voltage when the grip position A1 or the grip position A5 is gripped, the detection circuit erroneously determines that the pen-type electronic apparatus is gripped with a voltage of noise or the like.

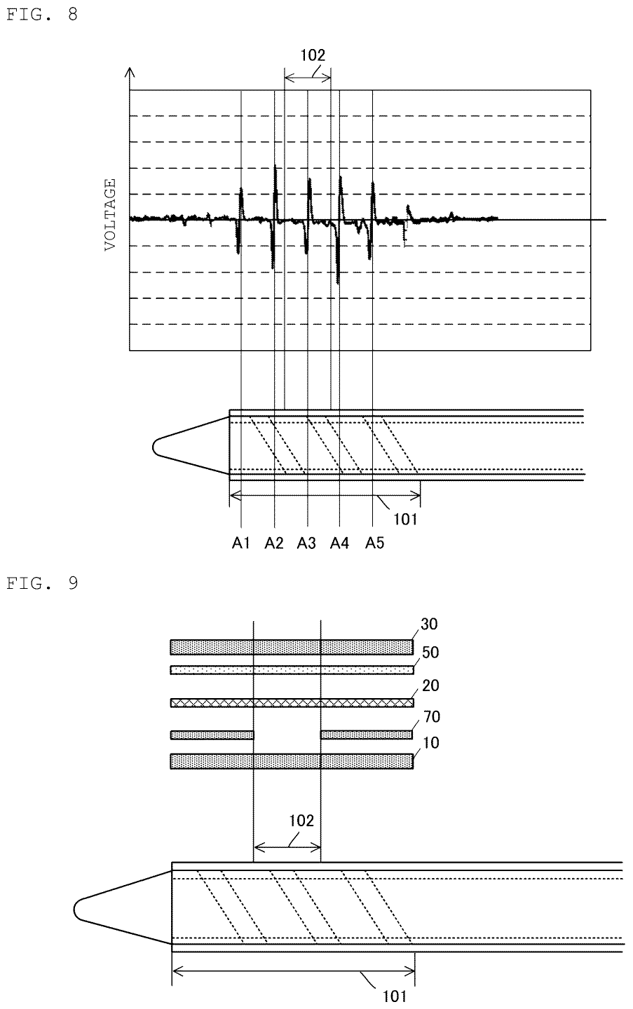

Therefore, the pen-type electronic apparatus 1 of the present embodiment has a low-sensitivity region where a sensitivity of the pressure sensor decreases in a central portion 102. FIG. 7 is a view illustrating a section of a part of the grip portion 101 of the pen-type electronic apparatus 1.

As illustrated in FIG. 7, the cushion material 50 has a cutout portion 51 in the central portion 102. As described above, when the user grips the grip portion 101, the housing 30 is first deformed. When the housing 30 is deformed, the cushion material 50 is also deformed. When the cushion material 50 is deformed, the pressure sensor 20 is also deformed in accordance with the deformation of the cushion material 50.

Therefore, as illustrated in FIG. 7, when the cushion material 50 has the cutout portion 51 in the central portion 102, a deformation amount of the pressure sensor 20 decreases in the central portion 102. As a result, the pressure sensor 20 forms the low-sensitivity region in the central portion 102. The low-sensitivity region in the central portion 102 has a lower-sensitivity for detecting pressure than other portions of the pressure sensor 20.

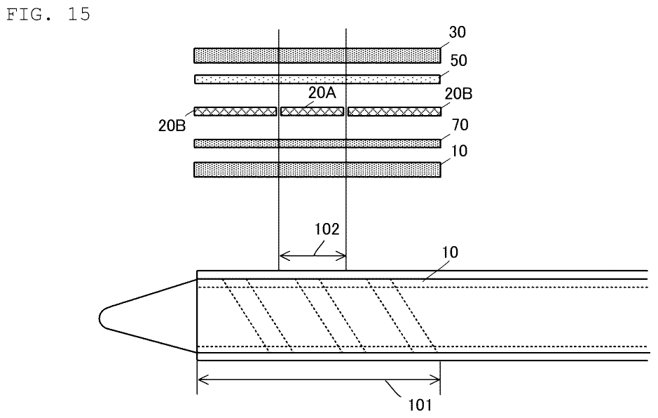

It is noted that, instead of the cushion material 50, a cutout portion 51 may be provided in the central portion 102 of the pressure sensor 20 according to another exemplary aspect. In addition, another cushion material relatively softer than the cushion material 50 may be provided at the position of the cutout portion 51. Furthermore, as illustrated in FIG. 13, a thin portion 90 may be provided in the central portion 102 of the housing 30. Also in these cases, the pressure sensor 20 forms the low-sensitivity region in the central portion 102.

FIG. 8 is a view illustrating a difference in output voltage of the pressure sensor depending on a place where the pen-type electronic apparatus is gripped in the pen-type electronic apparatus 1 of the present embodiment. A horizontal axis of a graph in the drawing corresponds to a grip position of the pen-type electronic apparatus, and a vertical axis is the voltage.

As illustrated in FIG. 8, in the pen-type electronic apparatus 1 of the present embodiment, there is no large difference in voltage regardless of which position of the grip positions A1 to A5 is gripped. Therefore, the detection circuit (not illustrated) can appropriately detect the gripping of the user without erroneously determining the gripping as noise or the like regardless of which position of the grip portion 101 is gripped by the user.

In the above-described embodiment, the example has been described in which the low-sensitivity region of the pressure sensor 20 is formed by the cushion material 50 having the cutout portion 51 in the portion corresponding to the central portion 102. However, it is noted that the low-sensitivity region can be formed by various modifications as follows.

### (First Modification)

According to an exemplary aspect, the cushion material 50 can have a thin portion in a portion corresponding to the low-sensitivity region of the pressure sensor 20 to form the low sensitivity region. Also in this case, the deformation amount of the pressure sensor 20 decreases in the central portion 102.

### (Second Modification)

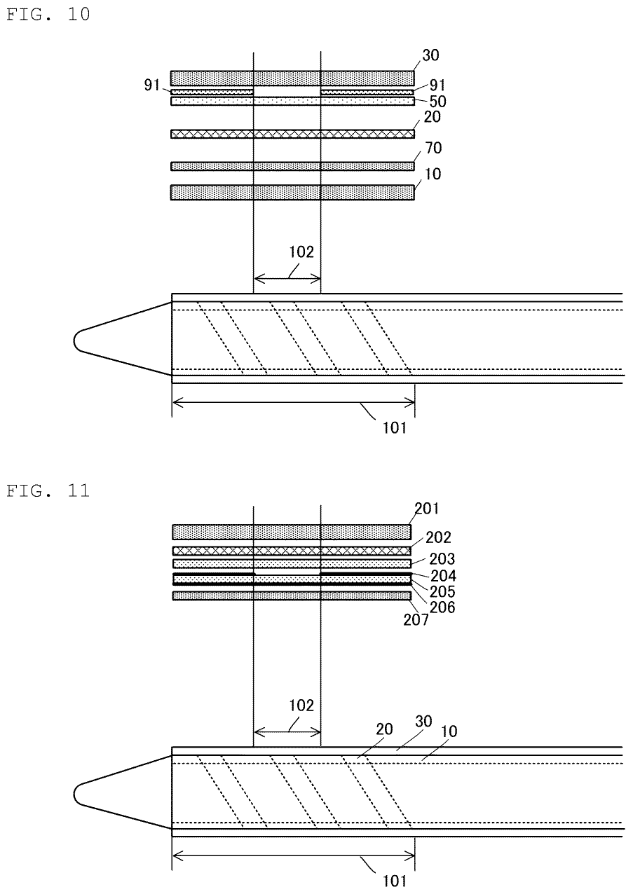

FIG. 9 is a view illustrating a section of a part of the grip portion 101 in a pen-type electronic apparatus 1 according to a second modification. As illustrated in FIG. 9, the bonding member 70 can have a cutout portion in a portion corresponding to the low-sensitivity region of the pressure sensor 20 to form the low-sensitivity region in an exemplary aspect. Also in this case, the deformation amount of the pressure sensor 20 decreases in the central portion 102.

### (Third Modification)

According to an exemplary aspect, the bonding member 70 can have a thin portion in the portion corresponding to the low-sensitivity region of the pressure sensor 20 to form the low sensitivity region. Also in this case, the deformation amount of the pressure sensor 20 decreases in the central portion 102.

### (Fourth Modification)

FIG. 10 is a view illustrating a section of a part of the grip portion 101 in a pen-type electronic apparatus 1 according to a fourth modification. As illustrated in FIG. 10, the pen-type electronic apparatus 1 according to the fourth modification includes a spacer 91 between the cushion material 50 and the housing 30. The spacer 91 has a cutout portion in a portion corresponding to the low-sensitivity region of the pressure sensor 20 (i.e., the central portion 102). Alternatively, instead of the spacer 91, a thickness of the cushion material 50 may be reduced only in the central portion 102 (or a thickness of other than the central portion 102 may be increased). As a result, the low-sensitivity region is formed in the central portion 102 of the pressure sensor 20. Also in this case, the deformation amount of the pressure sensor 20 decreases in the central portion 102.

### (Fifth Modification)

The spacer 91 has a thin portion in a portion corresponding to the low-sensitivity region of the pressure sensor 20 (the central portion 102). As a result, the low-sensitivity region is formed in the central portion 102 of the pressure sensor 20. Also in this case, the deformation amount of the pressure sensor 20 decreases in the central portion 102.

### (Sixth Modification)

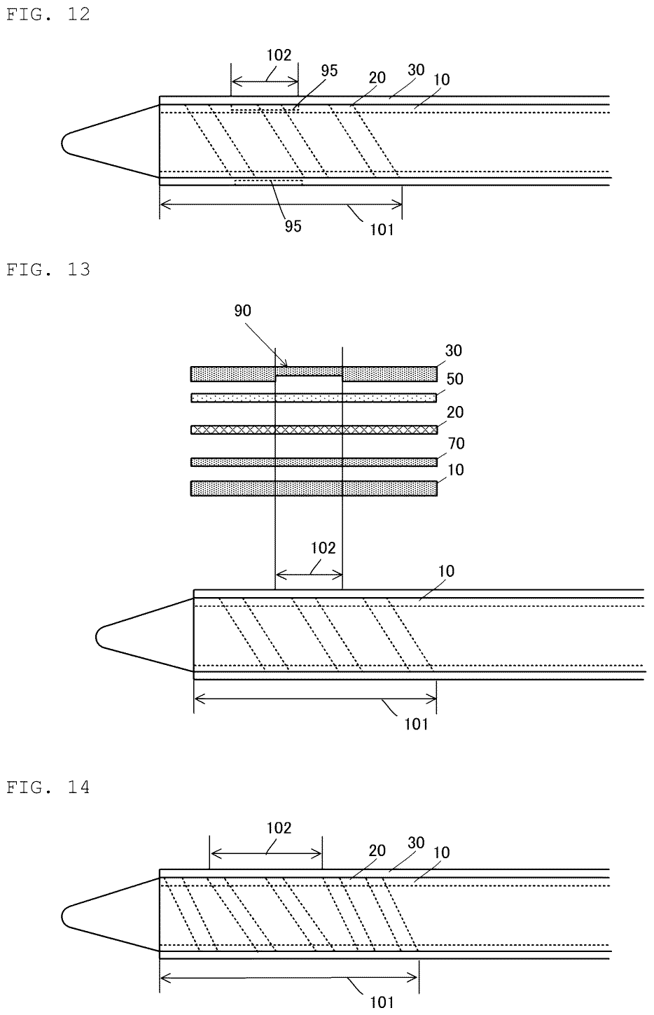

FIG. 11 is a view illustrating a section of a part of the pressure sensor 20 in a pen-type electronic apparatus 1 according to a sixth modification. As illustrated in FIG. 11, the second electrode 204 of the pressure sensor 20 has a cutout portion in the central portion 102. As a result, the low-sensitivity region is formed in the central portion 102 of the pressure sensor 20. Also in this case, the deformation amount of the pressure sensor 20 decreases in the central portion 102.

It is noted that an exemplary aspect may be adopted in which the piezoelectric film 202 of the pressure sensor 20 has a cutout portion in the central portion 102. Also in this case, the low-sensitivity region is formed in the central portion 102 of the pressure sensor 20. Also in this case, the deformation amount of the pressure sensor 20 decreases in the central portion 102. In addition, for example, the low-sensitivity region may be formed by supplementing a width of a central portion in a longitudinal direction of the piezoelectric film with respect to a width of each of end portions.

### (Seventh Modification)

FIG. 12 is a view illustrating a section of a part of the grip portion 101 in a pen-type electronic apparatus 1 in accordance with a seventh modification. As illustrated in FIG. 12, the pen shaft 10 has a thin portion in the central portion 102. As a result, the low-sensitivity region is formed in the central portion 102 of the pressure sensor 20. Also in this case, the deformation amount of the pressure sensor 20 decreases in the central portion 102.

### (Eighth Modification)

FIG. 14 is a view illustrating a section of a part of the pressure sensor 20 in a pen-type electronic apparatus 1 according to an eighth modification. In the above-described embodiment, the pressure sensor 20 is spirally wound at a uniform pitch along the outer surface of the pen shaft 10 in the portion corresponding to the grip portion 101. The pressure sensor 20 of the eighth modification is wound such that a pitch is short at the position of the central portion 102 and the pitch is long at positions other than the central portion 102. As a result, a smaller number of the pressure sensors are disposed in the central portion 102, and a larger number of the pressure sensors 20 are disposed at positions other than the central portion 102. Also in this case, the deformation amount of the pressure sensor 20 decreases in the central portion 102.

### (Ninth Modification)

FIG. 15 is a view illustrating a section of a part of the pressure sensor 20 in a pen-type electronic apparatus 1 according to a ninth modification. In the pen-type electronic apparatus 1 according to the ninth modification, the pressure sensor 20 is divided into a first pressure sensor 20A disposed at the position of the central portion 102 and second pressure sensors 20B disposed at the positions other than the central portion 102. The detection circuit (not illustrated) measures a voltage of each of the first pressure sensor 20A and the second pressure sensors 20B. Further, when the voltage of the first pressure sensor 20A exceeds a first threshold or the voltage of the second pressure sensors 20B exceeds a second threshold, the detection circuit determines that the grip portion 101 is gripped by the user. According to this exemplary aspect, the first threshold is set to a value higher than the second threshold. Also in this case, the low-sensitivity region where a sensitivity of the pressure sensor decreases is formed in the central portion 102.

Further, it is noted that piezoelectric films used for the first pressure sensor 20A and the second pressure sensors 20B may be polylactic acid uniaxially stretched in different directions. For example, when a uniaxial stretching direction of the piezoelectric film of the first pressure sensor 20A with respect to the axial direction of the pen shaft 10 is 20° and a uniaxial stretching direction of the piezoelectric film of the second pressure sensors 20B with respect to the axial direction of the pen shaft 10 is 45°, an output of the first pressure sensor 20A is low with respect to a same pressure force. That is, the uniaxial stretching direction of the piezoelectric film of the second pressure sensors 20B with respect to the axial direction of the pen shaft 10 is closer to 45° (or 135°) than the uniaxial stretching direction of the piezoelectric film of the first pressure sensor 20A with respect to the axial direction of the pen shaft 10. Also in this case, the low-sensitivity region where a sensitivity of the pressure sensor decreases is formed in the central portion 102.

When two types of sensors are used as described above, the sensor wound around the central portion and the sensor wound around the region other than the central portion may not be integrated.

In general, it is noted that the above embodiment and various modifications are examples, and can be appropriately combined. For example, sensors in a same uniaxial stretching direction may be divided into two and wound.

The technical concept of the exemplary aspects of the present embodiment are summarized as follows.

(1) A pen-type electronic apparatus, including: a cylindrical housing having a grip portion configured to be gripped by a user; a pen shaft housed inside the housing; a sheet-like pressure sensor wound around a position overlapping with the grip portion on an outer surface of the pen shaft or an inner surface of the housing; and a cushion material disposed between the pen shaft and the pressure sensor or between the pressure sensor and the housing. In this aspect, the pressure sensor has a low-sensitivity region in a central portion of the grip portion along a long axis direction of the pen shaft.

(2) The pen-type electronic apparatus according to the exemplary aspect (1), wherein the cushion material has a thin portion or a cutout portion in a portion corresponding to the low-sensitivity region, by which the low-sensitivity region is formed.

(3) The pen-type electronic apparatus according to the exemplary aspects (1) or (2), including a bonding member disposed between the pen shaft and the pressure sensor or between the pressure sensor and the housing, wherein the bonding member has a thin portion or a cutout portion in a portion corresponding to the low-sensitivity region, by which the low-sensitivity region is formed.

(4) The pen-type electronic apparatus according to any one of the exemplary aspects (1) to (3), wherein the pressure sensor has: a piezoelectric film; a first electrode disposed on a first principal surface of the piezoelectric film; and a second electrode disposed on a second principal surface of the piezoelectric film, and the first electrode or the second electrode has a cutout portion in a portion corresponding to the low-sensitivity region, by which the low-sensitivity region is formed.

(5) The pen-type electronic apparatus according to any one of the exemplary aspects (1) to (4), wherein the pen shaft has a thin portion in a portion corresponding to the low-sensitivity region, by which the low-sensitivity region is formed.

(6) The pen-type electronic apparatus according to any one of the exemplary aspect (1) to (5), further including a spacer disposed between the pen shaft and the pressure sensor or between the pressure sensor and the housing. In this aspect, the spacer has a thin portion or a cutout portion in a portion corresponding to the low-sensitivity region, by which the low-sensitivity region is formed.

(7) The pen-type electronic apparatus according to any one of the exemplary aspect (1) to (6), wherein the pressure sensor has: the piezoelectric film; the first electrode disposed on the first principal surface of the piezoelectric film; and the second electrode disposed on the second principal surface of the piezoelectric film, and the piezoelectric film has a cutout portion in a portion corresponding to the low-sensitivity region, by which the low-sensitivity region is formed.

(8) The pen-type electronic apparatus according to any one of the exemplary aspect (1) to (7), wherein the pressure sensor has an elongated shape and is spirally wound around the pen shaft.

### DESCRIPTION OF REFERENCE SYMBOLS

1: Pen-type electronic apparatus

10: Pen shaft

20: Pressure sensor

30: Housing

50: Cushion material

51: Cutout portion

70: Bonding member

91: Spacer

101: Grip portion

102: Central portion

201: First electrode

202: Piezoelectric film

203: Adhesive member

204: Second electrode

205: FPC

206: Third electrode

207: Cover

What is claimed:

1. A pen-type electronic apparatus, comprising:
a cylindrical housing having a grip portion structurally configured to be gripped by a user;
a pen shaft housed inside the cylindrical housing;
a sheet-like pressure sensor wound around a position that overlaps the grip portion on at least one of an outer surface of the pen shaft and an inner surface of the cylindrical housing; and
a cushion material disposed either between the pen shaft and the pressure sensor or between the pressure sensor and the cylindrical housing,
wherein the pressure sensor has a low-sensitivity region in a central portion of the grip portion along a long axis direction of the pen shaft, the low-sensitivity region having a lower sensitivity for detecting pressure from the user than other regions of the pressure sensor.

2. The pen-type electronic apparatus according to claim 1, wherein the cushion material has a portion corresponding to the low-sensitivity region that is thinner than the other regions of the pressure sensor.

3. The pen-type electronic apparatus according to claim 1, wherein the cushion material has a cutout in the central portion that corresponds to the low-sensitivity region.

4. The pen-type electronic apparatus according to claim 1, further comprising a bonding member disposed either between the pen shaft and the pressure sensor or between the pressure sensor and the housing.

5. The pen-type electronic apparatus according to claim 4, wherein the bonding member has a thin portion in the central portion and that corresponds to the low-sensitivity region.

6. The pen-type electronic apparatus according to claim 4, wherein the bonding member has a cutout portion in the central portion and that corresponds to the low-sensitivity region.

7. The pen-type electronic apparatus according to claim 1, wherein the pressure sensor has:
a piezoelectric film;
a first electrode disposed on a first principal surface of the piezoelectric film; and
a second electrode disposed on a second principal surface of the piezoelectric film.

8. The pen-type electronic apparatus according to claim 7, wherein at least one of the first electrode and the second electrode has a cutout portion in the central portion and that corresponds to the low-sensitivity region.

9. The pen-type electronic apparatus according to claim 1, wherein the pen shaft has a thin portion in the central portion and that corresponds to the low-sensitivity region.

10. The pen-type electronic apparatus according to claim 1, further comprising a spacer disposed either between the pen shaft and the pressure sensor or between the pressure sensor and the housing.

11. The pen-type electronic apparatus according to claim 10, wherein the spacer has a thin portion in the central portion and that corresponds to the low-sensitivity region.

12. The pen-type electronic apparatus according to claim 10, wherein the spacer has a cutout portion in the central portion and that corresponds to the low-sensitivity region.

13. The pen-type electronic apparatus according to claim 7, wherein the piezoelectric film has a cutout portion in the central portion and that corresponds to the low-sensitivity region.

14. The pen-type electronic apparatus according to claim 1, wherein the pressure sensor has an elongated shape and is spirally wound around the pen shaft.

15. The pen-type electronic apparatus according to claim 7, further comprising a detection circuit configured to measure a voltage potential difference between the first electrode and the second electrode and to determine that the grip portion is gripped by the user when the measured voltage potential difference is greater than a predetermined threshold.

16. The pen-type electronic apparatus according to claim 1, wherein the cushion material in the low-sensitivity region is softer than the cushion material in the other regions of the pressure sensor.

17. The pen-type electronic apparatus according to claim 1,
wherein the pressure sensor comprises a first pressure sensor corresponding to the low-sensitivity region and a second pressure sensor corresponding to the other regions,
wherein a detection circuit is configured to measure a voltage of the first pressure sensor and a voltage of the second pressure sensor, and
wherein the detection circuit is configured to determine that the grip portion is gripped by the user when the voltage of the first pressure sensor exceed a first threshold or the voltage of the second pressure sensor exceeds a second threshold that is lower than the first threshold.

18. A pen-type electronic apparatus, comprising:
a cylindrical housing having a grip portion configured to be gripped by a user;
a pen shaft inside the cylindrical housing;
a sheet-like pressure sensor wound around a position that overlaps the grip portion and is between the pen shaft and the cylindrical housing; and
a cushion material disposed between the pen shaft and the cylindrical housing,
wherein the pressure sensor has a central portion relative to a long axis direction of the cylindrical housing that has a lower sensitivity for detecting pressure when the user grips the cylindrical housing than other regions of the pressure sensor that are on either side of the central portion.

19. The pen-type electronic apparatus according to claim 18, wherein the cushion material is disposed between the pen shaft and the pressure sensor.

20. The pen-type electronic apparatus according to claim 18, wherein the cushion material is disposed between the pressure sensor and the cylindrical housing.
